(19) United States
(12) Patent Application Publication
(10) Pub. No.: US 2022/0330590 A1
(43) Pub. Date: Oct. 20, 2022

(54) TASTE-IMPROVING AGENT FOR HIGH-INTENSITY SWEETENER CONTAINING CAROTENOID DEGRADATION PRODUCT AS ACTIVE INGREDIENT

(71) Applicant: J-OIL MILLS, Inc., Tokyo (JP)

(72) Inventors: Shun MATSUZAWA, Tokyo (JP); Masayoshi SAKAINO, Tokyo (JP); Takahiro TOKUCHI, Tokyo (JP); Takashi SANO, Tokyo (JP)

(21) Appl. No.: 17/760,671

(22) PCT Filed: Sep. 28, 2020
(86) PCT No.: PCT/JP2020/036683

§ 371 Date: Mar. 15, 2022

(30) Foreign Application Priority Data
Oct. 24, 2019 (JP) 2019-193157

(51) Int. Cl. A23L 27/00; A23L 27/30; A23C 9/13

(52) U.S. Cl. CPC A23L 27/84; A23L 27/88; A23L 27/30; A23C 9/1307; A23C 9/1315; A23V 2002/00

(57) ABSTRACT

A taste-improving agent for a high-intensity sweetener, the taste-improving agent having a carotenoid degradation product as an active ingredient. The taste-improving agent can be formulated through a manufacturing method that includes a step for carrying out an oxidation treatment on carotenoids in an oil and fat to obtain a carotenoid degradation product. The carotenoid degradation product is preferably obtained by degrading one or more selected from the group consisting of carotenes and xanthophylls. The taste-improving agent is suitably used as a food product ingredient, etc., for improving the taste of, inter alia, a food product that includes a high-intensity sweetener.

### TECHNICAL FIELD

The present invention relates to a carotenoid degradation product having an exceptional effect for improving the taste of a high-intensity sweetener, and a use for the carotenoid degradation product.

### BACKGROUND ART

It is known that high-intensity sweeteners such as sucralose, aspartame, stevia, acesulfame potassium (acesulfame K), advantame, and neotame can impart sweetness similar to that of sucrose when added in small amounts due to having sweetness ranging from several tens to several thousands of times that of sucrose. Therefore, in response to recent trends for healthier lifestyles, high-intensity sweeteners are used instead of sugar or other sweeteners to lower the calorific content in food products, and the number of such food products has been increasing. However, improvement of high-intensity sweeteners in terms of taste, such as a characteristic acrid flavor and unnatural sweetness, has become a major issue. Specifically, although high-intensity sweeteners are useful in terms of being capable of imparting sweetness when added in small amounts, these high-intensity sweeteners also have off-flavors not present in typical sweeteners such as sugar, this being a primary factor impairing the value of food products.

In relation to such issues, for example, Patent Document 1 discloses reducing the bitterness of high-intensity sweeteners by using a specific amino acid such as L-asparagine. In addition, Patent Document 2 discloses improving an aftertaste in sucralose-containing beverages by using a specific organic acid such as malic acid. Furthermore, Patent Document 3 discloses improving unpleasant off-flavors, etc., in high-intensity sweeteners by using glucosamine or N-acetyl glucosamine. However, in view of the preferences of consumers and the increasingly diverse needs of enterprise involved in the foodstuffs trade, etc., it has become desirable to provide novel ingredients of non-conventional origin.

### RELATED ART DOCUMENTS

### Patent Documents

[Patent Document 1] Japanese Laid-Open Patent Application No. 2000-270804
[Patent Document 2] Japanese Laid-Open Patent Application No. 2003-210147
[Patent Document 3] Japanese Laid-Open Patent Application No. 2015-142521

### DISCLOSURE OF THE INVENTION

### Problems the Invention is Intended to Solve

It is an object of the present invention to improve the sweetness of a high-intensity sweetener and to improve taste by masking an acrid flavor.

### Means for Solving the Problems

As a result of thorough investigations carried out in order to resolve the problem described above, the inventors discovered that the taste of a high-intensity sweetener can be improved if a carotenoid degradation product is used, whereby the inventors perfected the present invention.

[1] A taste-improving agent for a high-intensity sweetener, the taste-improving agent containing a carotenoid degradation product as an active ingredient.

[2] The taste-improving agent according to [1], wherein the carotenoid degradation product is obtained by degrading one or more selected from the group consisting of carotenes and xanthophylls.

[3] The taste-improving agent according to [1] or [2], wherein the taste-improving agent contains the carotenoid degradation product in an amount of 1 mass ppm or more and 40000 mass ppm or less in terms of the amount of pre-degraded carotenoids.

[4] The taste-improving agent according to any of [1] to [3], wherein the carotenoid degradation product is obtained by degrading a carotenoid through heating and oxidation.

[5] The taste-improving agent according to any of [1] to [4], wherein the taste-improving agent is in the form of an oil and fat composition.

[6] The taste-improving agent according to [5], wherein the taste-improving agent is in the form of a powdered oil and fat containing the carotenoid degradation product.

[7] The taste-improving agent according to any of [1] to [4], wherein the taste-improving agent is in the form of an aqueous solution containing the carotenoid degradation product.

[8] A method for manufacturing a taste-improving agent for a high-intensity sweetener, the method including a step for carrying out an oxidation treatment on carotenoids in an oil and fat to obtain a carotenoid degradation product.

[9] The manufacturing method according to [8], wherein the oil and fat is obtained through a step for adding a carotenoid to a raw-material oil and fat.

[10] The manufacturing method according to [8], wherein the oil and fat is a palm-based oil and fat in which the total β-carotene and α-carotene content is 50 mass ppm or more and 2000 mass ppm or less.

[11] The manufacturing method according to any of [8] to [10], wherein the oil and fat has an iodine value of 0 or greater and 140 or lower.

[12] The manufacturing method according to any of [8] to [11], wherein the oxidation treatment involves oxidizing the oil and fat so as to reach a peroxide value of 3 or greater and 250 or lower.

[13] The manufacturing method according to any of [8] to [12], wherein the oxidation treatment is carried out through a heat treatment at a temperature of 50° C. or greater and 220° C. or lower for 0.1 hour or more and 240 hours or less.

[14] The manufacturing method according to any of [8] to [13], wherein the oxidation treatment is carried out with oxygen supplying.

[15] The manufacturing method according to any of [8] to [14], wherein the method also includes a step for mixing the carotenoid degradation product with an oil and fat.

[16] The manufacturing method according to any of [8] to [15], wherein the carotenoid degradation product is included in the taste-improving agent in an amount of 1 mass ppm or more and 40000 mass ppm or less in terms of the amount of pre-degraded carotenoids.

[17] The manufacturing method according to any of [8] to [16], wherein the oxidation treatment is carried out through heat treatment under conditions such that the integration amount obtained by multiplying the heating temperature (° C.) by the heating time (hours) is 20 or more and 20000 or less.

[18] The manufacturing method according to any of [8] to [17], wherein the method also includes a step for powderizing the carotenoid degradation product together with a solid fat.

[19] The manufacturing method according to any of [8] to [17], wherein the method also includes a step for mixing the carotenoid degradation product with water and harvesting an aqueous phase to obtain an aqueous solution of the carotenoid degradation product.

[20] The manufacturing method according to [19], wherein the method also includes a step for adding a diluent to the aqueous solution and performing spray-drying to obtain a powder that contains the carotenoid degradation product.

[21] A method for improving the taste of a food product that includes a high-intensity sweetener, the method involving incorporating a carotenoid degradation product into the food product.

[22] The taste improvement method according to [21], wherein the carotenoid degradation product is incorporated into the food product in an amount of 1×10⁻⁵ mass ppm or more and 1 mass ppm or less in terms of the amount of pre-degraded carotenoids.

[23] A method for manufacturing a food product that includes a high-intensity sweetener, the method including a step for adding a carotenoid degradation product to a food product.

[24] A high-intensity sweetener composition including a high-intensity sweetener and a carotenoid degradation product.

### Effect of the Invention

According to the present invention, it is possible to provide a taste-improving agent that has an exceptional effect for improving the taste of a high-intensity sweetener due to use of a carotenoid degradation product as an active ingredient.

### MODE FOR CARRYING OUT THE INVENTION

The present invention is a taste-improving agent for a high-intensity sweetener, the taste-improving agent having a carotenoid degradation product as an active component. The taste-improving agent has functions by which the taste of a high-intensity sweetener can be improved, such as by suppressing an acrid flavor that is characteristic of high-intensity sweeteners, and by which sweetness close to that of sugar is perceived.

The carotenoid degradation product used in the present invention is obtained by degrading a carotenoid. Examples of the carotenoid include: β-carotene, α-carotene, lycopene, and other carotenes; lutein, canthaxanthin, β-cryptoxanthin, astaxanthin, zeaxanthin, fucoxanthin, violaxanthin, lycopene, crocin, capsanthin, and other xanthophylls; and retinol, bixin, norbixin, crocetin, and other apocarotenoids. Among these, one or more selected from the group consisting of carotenes and xanthophylls is preferred; one or more selected from the group consisting of β-carotene, α-carotene, and astaxanthin is more preferred; one or more selected from the group consisting of β-carotene and astaxanthin is even more preferred; and β-carotene is yet even more preferred.

Insofar as carotenoid degradation products are edible dyes, etc., that are approved/acknowledged as food product additives, carotenoid degradation products can more preferably be used because the safety thereof as edible components is generally confirmed. One carotenoid degradation product may be used alone, two or more thereof may be used in combination, or two or more carotenoids may be combined and degraded in a mixed state.

The carotenoid degradation product is not particularly limited, but is preferably obtained by carrying out an oxidation treatment on a carotenoid in an oil and fat, and is more preferably obtained by carrying out a heating and oxidation treatment on a carotenoid in an oil and fat. The method for carrying out the heating and oxidation treatment is not particularly limited; however, from the standpoint of production on an industrial scale, it is preferable to accommodate the carotenoid in a suitable container, such as a tank, and then carry out the heating and oxidation treatment using heating means that heats via, e.g., thermoelectric conversion, direct-flame burners, microwaves, steam, or hot blasts of air, said heating means being provided to the container.

The taste-improving agent contains the carotenoid degradation product preferably such that the carotenoid degradation product content is 1 mass ppm or more and 40000 mass ppm or less, more preferably such that the carotenoid degradation product content is 10 mass ppm or more and 30000 mass ppm or less, and even more preferably such that the carotenoid degradation product content is 30 mass ppm or more and 20000 mass ppm or less, in terms of the amount of pre-degraded carotenoids.

The carotenoid degradation product may be added to another suitable edible oil and fat (also referred to below as “oil and fat”), as appropriate, within a range in which the desired function of improving the taste of a high-intensity sweetener is not hindered, and an oil and fat composition in which the carotenoid degradation product is incorporated may be produced. Examples of the other edible oil and fat include: soybean oil, rapeseed oil, palm oil, corn oil, olive oil, sesame oil, safflower oil, sunflower oil, cottonseed oil, rice bran oil, peanut oil, palm kernel oil, coconut oil, and other vegetable oils and fats; beef tallow, lard, chicken fat, fish oil, milk fat, and other animal oils and fats; and medium-chain fatty acid triglycerides, or processed oils and fats obtained by implementing fractionation, hydrogenation, transesterification, etc., on these oils and fats. One of the edible oils and fats may be used alone, or two or more thereof may be mixed together. In the oil and fat composition, one carotenoid degradation product may be incorporated alone into the other edible oil and fat, or two or more carotenoid degradation products may be used in combination. When two or more carotenoid degradation products are used in combination, the amount of the carotenoid degradation product is the total amount of the two or more carotenoid degradation products.

The amount of the carotenoid degradation product added to the edible oil and fat is preferably such that the carotenoid degradation product content is 1 mass ppm or more and 40000 mass ppm or less, more preferably such that the carotenoid degradation product content is 10 mass ppm or more and 30000 mass ppm or less, and even more preferably such that the carotenoid degradation product content is 30 mass ppm or more and 20000 mass ppm or less, in terms of the amount of pre-degraded carotenoids.

In the present invention, there is provided a method for manufacturing a taste-improving agent for a high-intensity sweetener, the method including a step for carrying out an oxidation treatment on carotenoids in an oil and fat to obtain a carotenoid degradation product.

The carotenoid degradation product can be obtained through a prescribed heat treatment, etc., that is performed while oxygen (air) is being discretionarily blown in. The carotenoid degradation product may also be extracted or concentrated, as appropriate, from an oil and fat composition containing the carotenoid-derived material. The method for extraction or concentration is not particularly limited; for example, it is possible to employ an extraction method in which an organic solvent is used, or a concentration method carried out through gas chromatography, molecular distillation, or steam distillation.

The oil and fat used in the oxidation treatment can be obtained through a step for adding the carotenoid to a raw-material oil and fat. It is preferable to use one or more selected from the group consisting of medium-chain fatty acid triglycerides and vegetable oils and fats, more preferable to use one or more selected from the group consisting of medium-chain fatty acid triglycerides and rapeseed oil, and even more preferable to use medium-chain fatty acid triglycerides as the raw-material oil and fat. The iodine value (also referred to below as “IV”) of the oil and fat used in the oxidation treatment is preferably 0 or greater and 140 or lower, more preferably 0 or greater and 130 or lower, and even more preferably 0 or greater and 120 or lower. The carotenoid content of the oil and fat used in the oxidation treatment is preferably 1 mass ppm or more and 40000 mass ppm or less, more preferably 10 mass ppm or more and 30000 mass ppm or less, and even more preferably 30 mass ppm or more and 20000 mass ppm or less.

The oil and fat used in the oxidation treatment may be a palm-based oil and fat in which the total β-carotene and α-carotene content is 50 mass ppm or more and 2000 mass ppm or less. The palm-based oil and fat used in the present invention is desirably an oil and fat obtained from oil palm fruit, and may be subjected to molecular distillation, fractionation, degumming, deacidification, decoloration, deodorization, or other treatments. The methods for carrying out these treatments are not particularly limited; methods that are normally used in treatments for processing/refining oils and fats can be employed. For example, fractionation can be carried out through solvent fractionation or low-temperature filtration.

The total β-carotene and α-carotene content included in the palm-based oil and fat is preferably 50 mass ppm or more and 1000 mass ppm or less, more preferably 80 mass ppm or more and 500 mass ppm or less, and even more preferably 120 mass ppm or more and 500 mass ppm or less. One palm-based oil and fat may be used alone such that the total β-carotene and α-carotene content is within these ranges, or two or more palm-based oils and fats may be used in combination and blended so as to reach these ranges.

The IV of the palm-based oil and fat is preferably 20 or greater and 90 or lower, more preferably 40 or greater and 80 or lower, and even more preferably 50 or greater and 70 or lower.

The oxidation treatment performed on the palm-based oil and fat preferably involves oxidation such that the peroxide value (also referred to below as “POV”) of the palm-based oil and fat is 3 or greater and 250 or lower, more preferably involves oxidation such that the POV is 10 or greater and 200 or lower, even more preferably involves oxidation such that the POV is 50 or greater and 120 or lower, and yet even more preferably involves oxidation such that the POV is 50 or greater and 100 or lower. Oxidizing the palm-based oil and fat makes it possible to achieve a POV within the prescribed ranges, but the method of oxidation is not particularly limited. Setting the POV within the prescribed ranges makes it possible to degrade the carotenoids in the palm-based oil and fat.

From the standpoint of production on an industrial scale, the oxidation treatment preferably involves accommodating the carotenoid in a suitable container, such as a tank, and then carrying out a prescribed heat treatment using heating means that heats via, e.g., thermoelectric conversion, direct-flame burners, microwaves, steam, or hot blasts of air, said heating means being provided to the container. The conditions of the heat treatment are desirably set such that a desired amount of a resultant product (e.g., carotenoid degradation product) is obtained, as appropriate. Heating conditions differ depending on, inter alia, the type of carotenoid and the type of raw-material oil and fat used as a base oil, the results depending on which conditions are employed; however, it is typical to perform heating, e.g., at a heating temperature of 50° C. or greater and 220° C. or lower for a heating time of 0.1 hours or more and 240 hours or less, and more typical to perform heating, e.g., at a heating temperature of 60° C. or greater and 160° C. or lower for a heating time of one hour or more and 100 hours or less. As conditions for an integration amount obtained by multiplying heating temperature (° C.) by heating time (hours) (also referred to below as “temperature×time”), it is typical to perform the heat treatment using an integration amount of, e.g., 200 or more and 20000 or less, more typical to perform the heat treatment using an integration amount of, e.g., 300 or more and 16000 or less, and even more typical to perform the heat treatment using an integration amount of, e.g., 400 or more and 14000 or less; these conditions are desirably set, as appropriate, such that a desired amount of a resultant product (e.g., carotenoid degradation product) is obtained.

During the oxidation treatment, oxygen may be taken in from an open space in the container by stirring, or oxygen may be blown in, to supply the oxygen (air). Air, etc., may be used as an oxygen source. This promotes degradation of the carotenoid. In this case, the amount of oxygen supplied is preferably set to 0.001-2 L/min per kilogram of the oil and fat used in the oxidation treatment. For example, when air is used, the amount supplied is preferably 0.005-10 L/min, and even more preferably 0.01-5 L/min, per kilogram of the oil and fat used in the oxidation treatment.

The oxidation treatment product containing the resulting carotenoid degradation product may furthermore be mixed with another oil and fat to form an oil and fat composition. Examples of the other edible oil and fat for manufacturing the oil and fat composition include: soybean oil, rapeseed oil, palm oil, corn oil, olive oil, sesame oil, safflower oil, sunflower oil, cottonseed oil, rice bran oil, peanut oil, palm kernel oil, coconut oil, and other vegetable oils and fats; beef tallow, lard, chicken fat, milk fat, and other animal oils and fats; and medium-chain fatty acid triglycerides, or processed oils and fats obtained by implementing fractionation, hydrogenation, transesterification, etc., on these oils and fats. One other edible oil and fat may be used alone, or an article in which two or more are mixed may be used.

The blending ratio is not particularly limited; however, the carotenoid degradation product content, relative to the total amount of the other edible oil and fat and the oxidation treatment product containing the carotenoid degradation product, is preferably 1 mass ppm or more and 40000 mass ppm or less, more preferably 10 mass ppm or more and 30000 mass ppm or less, and even more preferably 30 mass ppm or more and 20000 mass ppm or less, in terms of the amount of carotenoids. In the oil and fat composition, one type of oxidation treatment product containing a carotenoid degradation product may be incorporated alone into the other edible oil and fat, or two or more types of oxidation treatment product may be used in combination.

According to the present invention, the taste-improving agent described above is incorporated into, inter alia, a food product that contains a high-intensity sweetener, whereby it is possible to improve the taste of the high-intensity sweetener. More specifically, the present invention has an exceptional improvement effect with respect to off-flavors, etc., produced by high-intensity sweeteners. “Off-flavors” refers to an acrid flavor, etc., when the food product, etc., is tasted, or refers to unnatural sweetness and other tastes that are characteristic of high-intensity sweeteners. “Improving” includes not only reducing or suppressing the off-flavors, but also eliminating from being perceived with such flavors, or bringing the taste closer to the sweet flavor presented by sugar and other typical sweeteners. In particular, according to the present invention, the effect for suppressing an acrid flavor remaining in an aftertaste upon consumption and the effect for bringing the taste closer to the sweetness of sugar are exceptional. Such effects for improving the presence of off-flavors of high-intensity sweeteners or improving the taste produced by the high-intensity sweeteners can be objectively assessed through, e.g., a sensory evaluation conducted by panel experts who satisfy impartial standards.

The high-intensity sweeteners to which the present invention is applied are not particularly limited, but are natural or synthetic compounds having a sweetness at least ten times that of sucrose, or more preferably at least 100 times that of sucrose. Examples include: stevia, luo han guo extract, glycyrrhizin, glycyrrhizinic acid salts, thaumatin, and other natural sweeteners; and sucralose, acesulfame potassium, amino-acid-based sweeteners (aspartame, advantame, alitame, neotame, etc.), saccharin, sodium saccharin, dulcin, and other synthetic sweeteners. Among these, one or more selected from the group consisting of stevia, sucralose, acesulfame potassium, and aspartame is preferred; one or more selected from the group consisting of stevia and acesulfame potassium is more preferred; and stevia is even more preferred. In terms of an effect for masking an acrid flavor remaining in an aftertaste upon consumption, one or more selected from the group consisting of stevia and acesulfame potassium is preferred, and stevia is more preferred.

The amount of the taste-improving agent of the present invention that is blended into a food product, etc., is not particularly limited; if the carotenoid degradation product is used as an indicator, it is preferable to incorporate the oil and fat composition containing the carotenoid degradation product into a food product, etc., such that the total amount of the carotenoids and degradation products thereof is 1×10⁻⁵ mass ppm or more and 1 mass ppm or less, more preferable to incorporate the oil and fat composition such that said total amount is 1×10⁻⁴ mass ppm or more and 1 mass ppm or less, even more preferable to incorporate the oil and fat composition such that said total amount is 1×10⁻³ mass ppm or more and 1 mass ppm or less, and yet even more preferable to incorporate the oil and fat composition such that said total amount is 1×10⁻² mass ppm or more and 1 mass ppm or less, as an amount in terms of the amount of carotenoids prior to the degradation step.

The food product, etc., to which the present invention is applied is not particularly limited, provided that the food product, etc., contains the high-intensity sweetener. The food product, etc., may also contain sugar or another sweetener other than the high-intensity sweetener. Oral medicines, pet food, and animal feed, which are substances that are orally ingested by humans or animals, are also included. More specifically, examples of the food product, etc., include: processed products obtained from fruits, vegetables, seafood, etc.; surimi; cooked food products; sozai; snack foods; processed food products; nutritional food products; tea beverages, coffee beverages, fruit juice beverages, carbonated beverages, soft drinks, functional beverages, alcoholic beverages, sports drinks, and other beverages; ice cream, sherbet, and other frozen desserts; gelatin-based desserts, candies, gummi candies, gum, pudding, yokan, and other desserts; cookies, cakes, chocolate, chewing gum, manju, and other confectionery; sweet pastries, bread loaves, and other breads; jams; semihard tart candies, tablets, and other tablet candies; instant coffee, instant soup, and other instant food products; gum syrup, stick sugar, and other sweet preparations; seasonings; dressings; oral medicines; pet food; and animal feed. The high-intensity sweetener content of the food product is not particularly limited, and is, e.g., 0.00001-5 mass %, or preferably 0.00005-4 mass %.

As the form when the carotenoid degradation product is used in a food product, etc., it is desirable to employ a form in which the carotenoid degradation product can be maintained stably or in an excellent state of dispersion, said form being usable in a food product, etc.; this preparational form is not particularly limited. For example, the carotenoid degradation product may be formulated, through use of a preparational technique well known to ordinary persons skilled in the art, as a liquid oil and fat, margarine, fat spread, shortening, powdered oil and fat, etc., that mainly contains oil and fat components, or in the form of a solution, a powder, a gel, granules, etc., in which the blended amount of oil and fat components is low; these forms can be employed in a discretionary manner. The oxidation treatment product containing the carotenoid degradation product, or the oil and fat composition containing said oxidation treatment product, may, without further modification, be configured in one form for using the carotenoid degradation product to improve the taste of the food product. A powdered oil and fat containing the carotenoid degradation product can be formulated through a typical method for formulating a powdered oil and fat, such as a method involving spray-drying the carotenoid degradation product together with a solid fat.

As another form when the carotenoid degradation product is used in a food product, etc., it is permissible to employ the form of an aqueous solution containing the carotenoid degradation product. According to this configuration, it is possible to mix and use the carotenoid degradation product so as to have high affinity with an aqueous ingredient. This form of an aqueous solution can be formulated by causing, e.g., the carotenoid degradation product formulated in an oil phase through the oxidation treatment described above to transition to an aqueous phase using a typical liquid extraction means and then recovering the aqueous phase. A diluent selected as appropriate may be added to the harvested aqueous phase, and the resultant composition may be spray-dried, to achieve powderization. Dextrin is preferred as the diluent for this purpose.

When the carotenoid degradation product is used in a food product, etc., the amount of the carotenoid degradation product per 1 part by mass of the high-intensity sweetener contained in the food product, etc., is preferably 1×10⁻¹⁰ part by mass or more and 1×10⁻³ part by mass or less, more preferably 1×10⁻⁹ part by mass or more and 1×10⁻⁴ part by mass or less, even more preferably 1×10⁻⁸ part by mass or more and 1×10⁻⁵ part by mass or less, and yet even more preferably 1×10⁻⁷ part by mass or more and 1×10⁻⁶ part by mass or less, in terms of the amount of pre-degraded carotenoids.

From another standpoint, the present invention provides a high-intensity sweetener composition that contains a high-intensity sweetener and a carotenoid degradation product. According to this composition, adding the composition to a food product, etc., makes it possible to impart sweetness using the high-intensity sweetener, and the taste is additionally improved by the carotenoid degradation product. In the high-intensity sweetener composition according to the present invention, the amount of the carotenoid degradation product per 1 part by mass of the high-intensity sweetener is preferably 1×10⁻¹⁰ part by mass or more and 1×10⁻³ part by mass or less, more preferably 1×10⁻⁹ part by mass or more and 1×10⁻⁴ part by mass or less, even more preferably 1×10⁻⁸ part by mass or more and 1×10⁻⁵ part by mass or less, and yet even more preferably 1×10⁻⁷ part by mass or more and 1×10⁻⁶ part by mass or less, in terms of the amount of pre-degraded carotenoids.

### EXAMPLES

The present invention is described in even greater detail below through use of examples, but these examples in no way limit the present invention.

First, examples of palm-based oils and fats, base oils, and carotenoids that are used in the present examples are given, and methods for quantifying β-carotene, α-carotene, and astaxanthin are described, along with describing measurement of the peroxide value (POV) and measurement of the iodine value (IV).

(Palm-Based Oil and Fat)
Red palm oil 1 (molecularly distilled, fractionated one time): IV=58, total β-carotene and α-carotene content was 373 mass ppm, trade name “Carotino pure olein” (manufactured by Carotino)
Red palm oil 2 (molecularly distilled, fractionated one time): IV=58, total β-carotene and α-carotene content was 444 mass ppm, trade name “Carotino pure olein” (manufactured by Carotino)
Red palm oil 3 (molecularly distilled, fractionated one time): IV=58, total β-carotene and α-carotene content was 457 mass ppm, trade name “Carotino pure olein” (manufactured by Carotino)
Red palm oil 4 (non-refined, subjected to low-temperature filtration): IV=57, total β-carotene and α-carotene content was 341 mass ppm, trade name “EV redpalm oil” (manufactured by Rainforest Herb)
Compounded red palm oil: IV=58, obtained by compounding red palm oil 1 and palm olein (manufactured by J-Oil Mills, Inc. (proprietary formulation)) in ratio of 1:2; total β-carotene and α-carotene content was 115 mass ppm

(Base Oil and Carotenoid)
MCT (medium-chain fatty acid triglyceride): IV=0, trade name “Coconade MT” (manufactured by Kao Corp.)
Rapeseed oil: IV=115, trade name “Ajinomoto sarasara canola oil” (manufactured by J-Oil Mills, Inc.)
β-carotene: β-carotene 30% suspension (manufactured by DSM)
Astaxanthin: Astaxanthin oil Astabio AR5 (manufactured by Biogenic Co., Ltd.)

(Quantification of β-Carotene and α-Carotene)

The β-carotene and the α-carotene were quantified by analysis through high-performance liquid chromatography (HPLC analysis). Specifically, 0.5 g of a palm-based oil and fat or an oxidation treatment product was measured out, each of these components was diluted in a measuring flask using 10 mL of acetone and tetrahydrofuran in a ratio of 1:1, the diluted components were supplied for HPLC analysis, and the β-carotene content and α-carotene content were quantified from a calibration curve. The calibration curve was created, using a reagent (manufactured by Wako Pure Chemical Industries, Ltd.) of β-carotene (model no. 035-05531) and α-carotene (035-17981) as a quantification formulation, from the peak area upon supply to HPLC analysis for each prescribed concentration. The primary analysis conditions are indicated below.

(HPLC Conditions)
Detector: Photodiode array detector “2996 Photodiode Array Detector” (Waters), detected at 300-600 nm
Column: Shim-pack VP-ODS, 4.6 mmID×250 mm, 4.6 μm (Shimadzu Corp.)
Column temperature: 50° C.
Injection amount: 5 μL
Flow rate: 1.2 mL/min
Mobile phase A: Acetonitrile
Mobile phase B: Ethanol
Mobile phase C: Acetone
Gradient conditions: Refer to table 1

TABLE 1
Gradient conditions

| | Mobile phase A | Mobile phase B | Mobile phase C |
|---|---|---|---|
| Minutes | (vol %) | (vol %) | (vol %) |
| 0 | 80 | 20 | 0 |
| 22.0 | 80 | 20 | 0 |
| 22.1 | 0 | 0 | 100 |
| 25.0 | 0 | 0 | 100 |
| 25.1 | 80 | 20 | 0 |
| 30.0 | 80 | 20 | 0 |

(Quantification of Astaxanthin)

The method for quantifying the astaxanthin is described below. This component was quantified by HPLC analysis. Specifically: 2 g of the carotenoid, an edible oil and fat to which the carotenoid was added, or an oxidized oil and fat composition was measured out; each of these components was diluted in a measuring flask using 10 mL of acetone; the diluted components were dissolved and supplied for HPLC analysis; and the astaxanthin content was quantified from a calibration curve. The calibration curve was created, using a reagent of astaxanthin (model no. 600113) (manufactured by MedKoo Biosciences) as a quantification formulation, from the peak area upon supply to HPLC analysis for each prescribed concentration. The primary analysis conditions are indicated below.

(HPLC Conditions)
Detector: Photodiode array detector “2996 Photodiode Array Detector” (Waters), detected at 400-600 nm
Column: YMC Carotenoid, 4.6 mmID×250 mm, 5 μm (YMC CO., LTD.)
Column temperature: 25° C.
Injection amount: 10 μL
Flow rate: 1.0 mL/min
Mobile phase A: Methanol
Mobile phase B: tert-butyl methyl ether
Mobile phase C: Water
Gradient conditions: Refer to table 2

TABLE 2
Gradient conditions

| | Mobile phase A | Mobile phase B | Mobile phase C |
|---|---|---|---|
| Minutes | (vol %) | (vol %) | (vol %) |
| 0 | 81 | 15 | 4 |
| 90.0 | 6 | 90 | 4 |
| 95.0 | 6 | 90 | 4 |
| 95.1 | 81 | 15 | 4 |
| 105.0 | 81 | 15 | 4 |

(Measurement of Peroxide Value (POV))

The POV was measured in conformance with “Standard methods for the analysis of fats, oils and related materials: 2.5.2 Peroxide value” (Japan Oil Chemists' Society).

(Measurement of Iodine Value (IV))

The IV was measured in conformance with “Standard methods for the analysis of fats, oils and related materials: 2.3.4 Iodine value” (Japan Oil Chemists' Society).

Examples of high-intensity sweeteners, granulated sugar, and yogurt that are used in the present examples are given below.

(High-Intensity Sweetener, Granulated Sugar, and Yogurt)
Stevia: Manufactured by Ikeda Tohka Industries Co., Ltd.
Acesulfame potassium: Manufactured by Hokudai Trading Co., Ltd.
Aspartame: Manufactured by Wako Pure Chemical Industries, Ltd.
Sucralose: Manufactured by Wako Pure Chemical Industries, Ltd.
Sweetener containing erythritol and sucralose: Trade name “Sugar cut zero granules” (manufactured by Asadaame Co., Ltd.) (referred to below as “Sugar cut”)
Granulated sugar: Manufactured by Pearl Ace Corp.
Yogurt: Trade name “Meiji Bulgaria yogurt LB81 low-sugar” (manufactured by Meiji Co., Ltd.)

### [Test Example 1] (Evaluation in Yogurt, Part 1)

<Formulation of Oxidation Treatment Product from Edible Oil and Fat>

The various palm-based oils and fats shown in table 3 were used to formulate oxidation treatment products thereof. Specifically, red palm oils containing β-carotene and α-carotene in prescribed amounts (mass ppm) were prepared, and heat treatment was carried out under the heat treatment conditions indicated in table 3 while the red palm oils were stirred, to obtain the oxidation treatment products of examples 1 to 6. The heat treatment was carried out while air was blown in a prescribed amount as shown in table 3. One raw-material red palm oil that was not subjected to the heat treatment was employed as comparative example 1 to serve as a control.

Table 3 shows each of the type of red palm oil used, the β-carotene content and α-carotene content of the red palm oil along with the total β-carotene and α-carotene content, the heat treatment conditions, the amounts of β-carotene and α-carotene remaining after heat treatment along with the total amount of β-carotene and α-carotene remaining, the values of the POV measured before and after heat treatment, and the temperature×time value. In example 5, the red palm oil was heated at 120° C. for five hours, and then was further heated at 80° C. for five hours.

TABLE 3

| | | | | | Heating conditions | | | | |
|---|---|---|---|---|---|---|---|---|---|
| | | Carotene content | | | Temperature | | Temperature | | Air blowing |
| | Raw-material oil and | mass ppm | | | 1 | Time | 2 | Time | amount |
| | fat for heat treatment | β-carotene | α-carotene | Total | ° C. | h | ° C. | h | L/min |
| Comparative | Red palm oil 1 | 222 | 151 | 373 | | | | | — |
| example 1 | (IV = 58) | | | | | | | | |
| Example 1 | Red palm oil 2 | 206 | 238 | 444 | 80 | 182 | | | 0.2 |
| | (IV = 58) | | | | | | | | |
| Example 2 | Red palm oil 3 | 209 | 248 | 457 | 103 | 53 | | | 0.01 |
| | (IV = 58) | | | | | | | | |
| Example 3 | Red palm oil 1 | 222 | 151 | 373 | 120 | 2 | | | 0.2 |
| | (IV = 58) | | | | | | | | |
| Example 4 | Compounded red palm | 72 | 43 | 115 | 103 | 64 | | | 0.2 |
| | oil (IV = 58) | | | | | | | | |
| Example 5 | Red palm oil 4 | 246 | 95 | 341 | 120 | 5 | 80 | 5 | 0.2 |
| | (IV = 57) | | | | | | | | |
| Example 6 | Red palm oil 1 | 222 | 151 | 373 | 103 | 40 | | | 0.2 |
| | (IV = 58) | | | | | | | | |

| | | | | POV | | |
|---|---|---|---|---|---|---|
| | Remaining amount of carotene | | | (meq/kg) | | |
| | (mass ppm) | | | Before heat | After heat | Temperature × |
| | β-carotene | α-carotene | Total | treatment | treatment | time* |
| Comparative | 222 | 151 | 373 | 1 | 1 | 0 |
| Example 1 | 0 | 0 | 0 | 1 | 80 | 14560 |
| Example 2 | 0 | 0 | 0 | 1 | 115 | 5459 |
| Example 3 | 145 | 120 | 265 | 1 | 8 | 240 |
| Example 4 | 0 | 0 | 0 | 1 | 216 | 6592 |
| Example 5 | 138 | 60 | 198 | 1 | 17 | 1000 |
| Example 6 | 0 | 2 | 2 | 1 | 56 | 4120 |

*Temperature 1 × time 1 + temperature 2 × time 2

As shown in table 3, the β-carotene content and α-carotene content included in the palm-based oil and fat decreased due to heat treatment, and carrying out heating for a longer period of time or raising the temperature made it possible to degrade all of the β-carotene and α-carotene in the palm-based oil and fat. Moreover, the value of the POV increased due to heat treatment. Whereas the total amount of β-carotene and α-carotene remaining in example 3 was 265 mass ppm, the total amount of β-carotene and α-carotene remaining in example 5 was 198 mass ppm; due to the increase in the temperature×time value, degradation of the β-carotene and α-carotene was promoted. In addition, as shall be apparent in examples 1, 2, 4, and 6, with the temperature×time value being 4000 or greater, it was possible to degrade 99% or more of the β-carotene and α-carotene in the red palm oil.

<Formulation of Edible Oil and Fat Composition>

1 mass % of the oil and fat compositions of examples 1 to 6, which were formulated by heat-treating the red palm oils and which contained carotenoid degradation products, was incorporated into rapeseed oil to formulate edible oil and fat compositions that contained 1.08-4.57 mass ppm of the carotenoid degradation products in terms of the amount of pre-oxidation-treatment carotenoids. In addition, 1 mass % of comparative example 1, which was one raw-material red palm oil not subjected to heat treatment, was incorporated into rapeseed oil as a control to formulate an edible oil and fat composition.

<Formulation and Evaluation of 1%-Stevia-Containing Yogurt>

1 mass % of stevia was incorporated into yogurt to produce high-intensity-sweetener-containing yogurt (also referred to below as “1%-stevia-containing yogurt”), and furthermore, a sensory evaluation was conducted on yogurt formulated by incorporating the edible oil and fat compositions formulated as described above into the high-intensity-sweetener-containing yogurt using the blends shown in table 4. Specifically, the quality of sweetness and the masking of an acrid flavor in an aftertaste upon consumption of the resultant yogurt were evaluated, where 1%-stevia-containing yogurt to which was added an edible oil and fat composition obtained through incorporation of comparative example 1, which was the one raw-material red palm oil not subjected to heat treatment, was used as control 1, and yogurt to which was added 5% of granulated sugar was used as control 2. The sensory evaluation was conducted by five panel experts, and moreover was conducted using an evaluation form in which ratings of 0, 1, 2, and 3 indicated by the following criteria were written on 6-cm-long line segments at intervals of 1 cm. Specifically, the panel experts plotted their evaluations on the line segments in a discretionary manner, the lengths from the rating 0 were measured in units of 0.1 cm, and said lengths were scored according to the following criteria that incorporated the evaluation values of the panel experts to thereby derive average evaluation values.

(Criteria)

(Quality of Sweetness)

3 Very close to sweetness of sugar (same as control 2)

2 Close to sweetness of sugar

1 Marginally close to sweetness of sugar

0 Different from sweetness of sugar (same as control 1)

(Masking of Acrid Flavor in Aftertaste)

3 Much weaker acrid flavor in aftertaste than with control 1, or no acrid flavor in aftertaste (same as control 2)

2 Weaker acrid flavor in aftertaste than with control 1

1 Slightly weaker acrid flavor in aftertaste than with control 1

0 Same acrid flavor in aftertaste as that in control 1, or stronger acrid flavor in aftertaste than with control 1

TABLE 4

| | | | | | | |
|---|---|---|---|---|---|---|
| Formulation | | | | | | |
| example 1-1 | Formulation | Formulation | Formulation | Formulation | Formulation | Formulation |
| (control 1) | example 1-2 | example 1-3 | example 1-4 | example 1-5 | example 1-6 | example 1-7 |

Blends

| | | | | | | | | |
|---|---|---|---|---|---|---|---|---|
| Edible oil | Rapeseed oil | 0.495 | 0.495 | 0.495 | 0.495 | 0.495 | 0.495 | 0.495 |
| and fat | Comparative | 0.005 | | | | | | |
| composition | example 1 | | | | | | | |
| (g) | Example 1 | | 0.005 | | | | | |
| | Example 2 | | | 0.005 | | | | |
| | Example 3 | | | | 0.005 | | | |
| | Example 4 | | | | | 0.005 | | |
| | Example 5 | | | | | | 0.005 | |
| | Example 6 | | | | | | | 0.005 |

| | | | | | | | |
|---|---|---|---|---|---|---|---|
| 1%-stevia-containing yogurt | 49.5 | 49.5 | 49.5 | 49.5 | 49.5 | 49.5 | 49.5 |
| Oil fraction (%) | 1 | 1 | 1 | 1 | 1 | 1 | 1 |
| Heat-treated oil and fat | | 100 | 100 | 100 | 100 | 100 | 100 |
| concentration (mass ppm) | | | | | | | |
| Heat-treated carotenoid | 0 | 0.0444 | 0.0457 | 0.0108 | 0.0115 | 0.0143 | 0.0371 |
| content* (mass ppm) | | | | | | | |
| Total mass (g) | 50 | 50 | 50 | 50 | 50 | 50 | 50 |

Results of sensory evaluation

| Quality of | Expert 1 | 0 | 2 | 1 | 1 | 1 | 2 | 2 |
|---|---|---|---|---|---|---|---|---|
| sweetness | Expert 2 | 0 | 2 | 2 | 2 | 1 | 2 | 2 |
| | Expert 3 | 0 | 1 | 2 | 2 | 1 | 2 | 1 |
| | Expert 4 | 0 | 1 | 2 | 1 | 1 | 2 | 2 |
| | Expert 5 | 0 | 2 | 2 | 1 | 1 | 3 | 2 |
| Median value | | 0.0 | 2.0 | 2.0 | 1.0 | 1.0 | 2.0 | 2.0 |
| Mean value | | 0.0 | 1.6 | 1.8 | 1.4 | 1.0 | 2.2 | 1.8 |
| Masking of | Expert 1 | 0 | 2 | 2 | 2 | 1 | 2 | 3 |
| acrid flavor | Expert 2 | 0 | 3 | 2 | 2 | 1 | 2 | 3 |
| in aftertaste | Expert 3 | 0 | 2 | 1 | 1 | 1 | 2 | 2 |
| | Expert 4 | 0 | 1 | 1 | 2 | 1 | 2 | 3 |
| | Expert 5 | 0 | 2 | 1 | 1 | 1 | 3 | 2 |

| | | | | | | | |
|---|---|---|---|---|---|---|---|
| Median value | 0.0 | 2.0 | 1.0 | 2.0 | 1.0 | 2.0 | 3.0 |
| Mean value | 0.0 | 2.0 | 1.4 | 1.6 | 1.0 | 2.2 | 2.6 |

*Amount in terms of total α-carotene and β-carotene content prior to heat treatment

These results, as shown in table 4, have clarified that the quality of sweetness of 1%-stevia-containing yogurt was more greatly improved and an effect for masking an acrid flavor in an aftertaste was more strongly obtained by the edible oil and fat compositions obtained by incorporating the oil and fat compositions of examples 1 to 6, which contained carotenoid degradation products, than by the edible oil and fat composition obtained by incorporating comparative example 1, which was the one raw-material red palm oil not subjected to heat treatment. In particular, the effect for improving the quality of sweetness of the 1%-stevia-containing yogurt and the effect for masking an acrid flavor in an aftertaste were increased in formulation examples 1-2, 1-3, 1-6, and 1-7, which contained edible oil and fat compositions obtained by incorporating the oil and fat compositions of examples 1, 2, 5, and 6 exhibiting POV values of 17-115 (refer to table 3). Furthermore, the effect for improving the quality of sweetness and the effect for masking an acrid flavor in an aftertaste were particularly increased in formulation example 1-7, which contained the edible oil and fat composition obtained by incorporating the oil and fat composition of example 6. In example 6, which was used in the yogurt of formulation example 1-7 for which these effects were recognized in the present sensory evaluation, the amount of the carotenoid degradation product per 1 part by mass of stevia was 3.7×10⁻⁶ parts by mass in terms of the amount of pre-degraded carotenoids.

### [Test Example 2] (Evaluation in Yogurt, Part 2)

0.1 mass % of the oil and fat compositions of examples 2 and 6 formulated according to table 3 was incorporated into rapeseed oil to formulate edible oil and fat compositions, which were incorporated into 1%-stevia-containing yogurt using the blends shown in table 5, and a sensory evaluation was conducted using the same method as in test example 1. As shown in table 5, the sensory evaluation was conducted by three panel experts, and in lieu of control 1 from test example 1, the 1%-stevia-containing yogurt of formulation example 2-1, which contained an edible oil and fat composition formulated by incorporating 0.1 mass % of comparative example 1 in table 3 into rapeseed oil, was set as control 1.

TABLE 5

| | | |
|---|---|---|
| Formulation | | |
| example 2-1 | Formulation | Formulation |
| (control 1) | example 2-2 | example 2-3 |

Blends

| | | | | |
|---|---|---|---|---|
| Edible oil and | Rapeseed oil | 0.4995 | 0.4995 | 0.4995 |
| fat composition | Comparative | 0.0005 | | |
| (g) | example 1 | | | |
| | Example 2 | | 0.0005 | |
| | Example 6 | | | 0.0005 |

| | | | |
|---|---|---|---|
| 1%-stevia-containing yogurt | 49.5 | 49.5 | 49.5 |
| Oil fraction (%) | 1 | 1 | 1 |
| Heat-treated oil and fat | | 10 | 10 |
| concentration (mass ppm) | | | |
| Heat-treated carotenoid | 0 | 0.00457 | 0.00371 |
| content* (mass ppm) | | | |
| Total mass (g) | 50 | 50 | 50 |

Results of sensory evaluation

| Quality of | Expert 1 | 0 | 1 | 2 |
|---|---|---|---|---|
| sweetness | Expert 2 | 0 | 1 | 1 |
| | Expert 3 | 0 | 2 | 1 |
| Median value | | 0.0 | 1.0 | 1.0 |
| Mean value | | 0.0 | 1.3 | 1.3 |
| Masking of | Expert 1 | 0 | 1 | 1 |
| acrid flavor | Expert 2 | 0 | 1 | 1 |
| in aftertaste | Expert 3 | 0 | 2 | 1 |

| | | | |
|---|---|---|---|
| Median value | 0.0 | 1.0 | 1.0 |
| Mean value | 0.0 | 1.3 | 1.0 |

*Amount in terms of total α-carotene and β-carotene content prior to heat treatment

These results, as shown in table 5, have clarified that the quality of sweetness of 1%-stevia-containing yogurt was more greatly improved and an effect for masking an acrid flavor in an aftertaste was more strongly obtained by the edible oil and fat compositions obtained by incorporating the oil and fat compositions of examples 2 and 6, which contained carotenoid degradation products, than by the edible oil and fat composition obtained by incorporating comparative example 1, which was the one raw-material red palm oil not subjected to heat treatment. Thus, it became obvious that the oil and fat composition that was formulated by heat-treating the red palm oil and that contained the carotenoid degradation product exhibited an effect for improving the taste of a high-intensity sweetener even when the carotenoid degradation product content thereof was reduced to 10 mass ppm in the yogurt. In example 6, which was used in the yogurt of formulation example 2-3 for which these effects were recognized in the present sensory evaluation, the amount of the carotenoid degradation product per 1 part by mass of stevia was 3.7×10⁻⁷ parts by mass in terms of the amount of pre-degraded carotenoids.

### [Test Example 3] (Evaluation in Yogurt, Part 3)

<Formulation and Evaluation of Other High-Intensity-Sweetener-Containing Yogurt>

Each of 0.5% of acesulfame potassium, 0.1% of aspartame, 0.05% of sucralose, and 3.5% of Sugar cut was incorporated into yogurt to produce the yogurts shown in table 6 (also referred to below as “0.5%-acesulfame-potassium-containing yogurt,” “0.1%-aspartame-containing yogurt,” “0.05%-sucralose-containing yogurt,” and “3.5%-Sugar-cut-containing yogurt,” respectively). 1 mass % of the oil and fat compositions of examples 2 and 6 formulated according to table 3 was incorporated into rapeseed oil to formulate edible oil and fat compositions, which were incorporated into each of the high-intensity-sweetener-containing yogurts using the blends shown in table 6, and a sensory evaluation was conducted using the same method as in test example 1. As shown in table 6, the sensory evaluation was conducted by three panel experts, and in lieu of control 1 from test example 1, the following high-intensity-sweetener-containing yogurts were set as respective controls 1. Formulation example 3-1: 0.5%-acesulfame-potassium-containing yogurt that contained an edible oil and fat composition formulated by incorporating 1 mass % of comparative example 1 in table 3 into rapeseed oil; formulation example 3-4: 0.1%-aspartame-containing yogurt that contained an edible oil and fat composition formulated by incorporating 1 mass % of comparative example 1 in table 3 into rapeseed oil; formulation example 3-7: 0.05%-sucralose-containing yogurt that contained an edible oil and fat composition formulated by incorporating 1 mass % of comparative example 1 in table 3 into rapeseed oil; formulation example 3-10: 3.5%-Sugar-cut-containing yogurt that contained an edible oil and fat composition formulated by incorporating 1 mass % of comparative example 1 in table 3 into rapeseed oil. The evaluation of an acrid flavor in an aftertaste was conducted only for formulation examples 3-1 to 3-3, which contained acesulfame potassium.

TABLE 6

| | | | | | |
|---|---|---|---|---|---|
| Formulation | Formulation | Formulation | Formulation | Formulation | Formulation |
| example 3-1 | example 3-2 | example 3-3 | example 3-4 | example 3-5 | example 3-6 |

Blends

| | | | | | | | |
|---|---|---|---|---|---|---|---|
| Edible oil | Rapeseed oil | 0.495 | 0.495 | 0.495 | 0.495 | 0.495 | 0.495 |
| and fat | Comparative | 0.005 | | | 0.005 | | |
| composition | example 1 | | | | | | |
| (g) | Example 2 | | 0.005 | | | 0.005 | |
| | Example 6 | | | 0.005 | | | 0.005 |

| | | | | | | |
|---|---|---|---|---|---|---|
| 0.5%-acesulfame-potassium- | 49.5 | 49.5 | 49.5 | | | |
| containing yogurt | | | | | | |
| 0.1%-aspartame-containing | | | | 49.5 | 49.5 | 49.5 |
| yogurt | | | | | | |
| 0.05%-sucralose-containing | | | | | | |
| yogurt | | | | | | |
| 3.5%-Sugar-cut-containing | | | | | | |
| yogurt | | | | | | |
| Oil fraction (%) | 1 | 1 | 1 | 1 | 1 | 1 |
| Heat-treated oil and fat | | 100 | 100 | 100 | 100 | 100 |
| concentration (mass ppm) | | | | | | |
| Heat-treated carotenoid | 0 | 0.0457 | 0.0371 | 0 | 0.0457 | 0.0371 |
| content* (mass ppm) | | | | | | |
| Total mass (g) | 50 | 50 | 50 | 50 | 50 | 50 |

Results of sensory evaluation

| Quality of | Expert 1 | 0 | 1 | 2 | 0 | 2 | 2 |
|---|---|---|---|---|---|---|---|
| sweetness | Expert 2 | 0 | 1 | 1 | 0 | 1 | 1 |
| | Expert 3 | 0 | 1 | 2 | 0 | 0 | 1 |
| Median value | | 0.0 | 1.0 | 2.0 | 0.0 | 1.0 | 1.0 |
| Mode value | | 0.0 | 1.0 | 1.7 | 0.0 | 1.0 | 1.3 |
| Masking of | Expert 1 | 0 | 1 | 2 | | | |
| acrid flavor | Expert 2 | 0 | 1 | 2 | | | |
| in aftertaste | Expert 3 | 0 | 1 | 1 | | | |

| | | | |
|---|---|---|---|
| Median value | 0.0 | 1.0 | 2.0 |
| Mode value | 0.0 | 1.0 | 1.7 |

| | | | | | |
|---|---|---|---|---|---|
| Formulation | Formulation | Formulation | Formulation | Formulation | Formulation |
| example 3-7 | example 3-8 | example 3-9 | example 3-10 | example 3-11 | example 3-12 |

Blends

| | | | | | | | |
|---|---|---|---|---|---|---|---|
| Edible oil | Rapeseed oil | 0.495 | 0.495 | 0.495 | 0.495 | 0.495 | 0.495 |
| and fat | Comparative | 0.005 | | | 0.005 | | |
| composition | example 1 | | | | | | |
| (g) | Example 2 | | 0.005 | | | 0.005 | |
| | Example 6 | | | 0.005 | | | 0.005 |

| | | | | | | |
|---|---|---|---|---|---|---|
| 0.5%-acesulfame-potassium- | | | | | | |
| containing yogurt | | | | | | |
| 0.1%-aspartame-containing | | | | | | |
| yogurt | | | | | | |
| 0.05%-sucralose-containing | 49.5 | 49.5 | 49.5 | | | |
| yogurt | | | | | | |
| 3.5%-Sugar-cut-containing | | | | 49.5 | 49.5 | 49.5 |
| yogurt | | | | | | |
| Oil fraction (%) | 1 | 1 | 1 | 1 | 1 | 1 |
| Heat-treated oil and fat | 100 | 100 | 100 | 100 | 100 | 100 |
| concentration (mass ppm) | | | | | | |
| Heat-treated carotenoid | 0 | 0.0457 | 0.0371 | 0 | 0.0457 | 0.0371 |
| content* (mass ppm) | | | | | | |
| Total mass (g) | 50 | 50 | 50 | 50 | 50 | 50 |

Results of sensory evaluation

| Quality of | Expert 1 | 0 | 1 | 1 | 0 | 2 | 1 |
|---|---|---|---|---|---|---|---|
| sweetness | Expert 2 | 0 | 1 | 1 | 0 | 2 | 2 |
| | Expert 3 | 0 | 1 | 1 | 0 | 1 | 2 |
| Median value | | 0.0 | 1.0 | 1.0 | 0.0 | 2.0 | 2.0 |
| Mode value | | 0.0 | 1.0 | 1.0 | 0.0 | 1.7 | 1.7 |
| Masking of | Expert 1 | | | | | | |
| acrid flavor | Expert 2 | | | | | | |
| in aftertaste | Expert 3 | | | | | | |

Median value
Mode value

*Amount in terms of total α-carotene and β-carotene content prior to heat treatment

In these results, as shown in table 6, an effect for improving the quality of sweetness was obtained in all of the high-intensity-sweetener-containing yogurts shown in table 6 by the edible oil and fat compositions that contained carotenoid degradation products. An acrid flavor in an aftertaste was evaluated only for the 0.5%-acesulfame-potassium-containing yogurt, the high-intensity sweetener therein having a particularly strong acrid flavor among the high-intensity sweeteners shown in table 6. The results of this evaluation have clarified that an effect for masking an acrid flavor in an aftertaste was obtained by the edible oil and fat compositions that contained carotenoid degradation products. In example 6, which was used in the yogurt of formulation examples 3-3, 3-6, and 3-9 for which these effects were recognized in the present sensory evaluation, the amount of the carotenoid degradation product per 1 part by mass of the respective high-intensity sweetener was 7.4×10⁻⁶ parts by mass for the acesulfame potassium, 3.7×10⁻⁵ parts by mass for the aspartame, and 7.4×10⁻⁵ parts by mass for the sucralose, in terms of the amount of pre-degraded carotenoids.

### [Test Example 4] (Evaluation in Cola, Part 1)

<Formulation of Edible Powdered Oil and Fat>

The raw materials listed in table 7 were mixed using the oil and fat composition of example 6, which included a carotenoid degradation product formulated by heat-treating red palm oil, and were spray-dried to obtain an edible powdered oil and fat of example 7. An edible powdered oil and fat of comparative example 2 was obtained as a control in the same manner, except that the oil and fat composition of example 6 was not used therein.

TABLE 7

| | | Comparative | |
|---|---|---|---|
| | | example 2 | Example 7 |
| | | (parts by | (parts by |
| Powdered oil and fat raw materials | | mass) | mass) |
| Oil phase | Ultrahardened palm kernel oil | 45 | 44 |
| (%) | Example 6 | | 1 |
| | Sorbitan fatty acid ester | 0.45 | 0.45 |
| | (Emasol P-10V, manufactured by | | |
| | Kao Corp.) | | |
| | Glycerol fatty acid ester | 0.45 | 0.45 |
| | (Poem P-200, manufactured by | | |
| | Riken Vitamin Co., Ltd.) | | |
| Aqueous | Acid casein (Lactic Casein, | 4.399 | 4.399 |
| phase (%) | Westland Co-operative Dairy | | |
| | Co., Ltd.) | | |
| | Sodium hydroxide | 0.101 | 0.101 |
| | Corn syrup (Fuji syrup C-75S, | 47.5 | 47.5 |
| | water content: 25 mass %, | | |
| | manufactured by Kato Kagaku | | |
| | Co., Ltd.) | | |
| | Dibasic potassium phosphate | 1.6 | 1.6 |
| | (manufactured by Taihei | | |
| | Chemical Industrial Co., Ltd.) | | |
| | Trisodium citrate (manufactured | 0.5 | 0.5 |
| | by San-Ei Gen FFI, Inc.) | | |

| | | |
|---|---|---|
| Total | 100 | 100 |
| Oil and fat content of powdered oil and | 45 mass % | 45 mass % |
| fat | | |
| Oxidation treatment product content of | | 1 mass % |
| powdered oil and fat | | |

<Formulation and Evaluation of Cola>

Cola (“Kirin Mets Cola” manufactured by Kirin Beverage Corp.) was heated to about 60° C., after which the powdered oil and fat of example 7 or comparative example 2 formulated as described above was added using the blends shown in table 8 and the mixture was stirred and then cooled to 4° C. The quality of sweetness of the resultant powdered-oil-and-fat-containing cola was evaluated by two panel experts. Specifically, the panel experts plotted their evaluations on the line segments in a discretionary manner, the lengths from the rating 0 were measured in units of 0.1 cm, and said lengths were scored according to the following criteria that incorporated the evaluation values of the panel experts to thereby derive average evaluation values.

(Criteria)

(Quality of Sweetness)

3 Very close to sweetness of sugar

2 Close to sweetness of sugar

1 Marginally close to sweetness of sugar

0 Different from sweetness of sugar (same as formulation example 4-1)

TABLE 8

| | |
|---|---|
| Formulation | Formulation |
| example 4-1 | example 4-2 |

Blends

| | | | |
|---|---|---|---|
| Powdered oil and | Comparative | 0.08 | |
| fat (g) | example 2 | | |
| | Example 7 | | 0.08 |

| | | |
|---|---|---|
| Cola | 79.92 | 79.92 |
| Oil fraction (%) | 0.045 | 0.045 |
| Heat-treated oil and fat | | 10 |
| concentration (mass ppm; | | |
| Heat-treated carotenoid content* | 0 | 0.00371 |
| (mass ppm) | | |
| Total mass (g) | 80 | 80 |

Results of sensory evaluation

| | | | |
|---|---|---|---|
| Quality of | Expert 1 | 0 | 1 |
| sweetness | Expert 2 | 0 | 2 |

| | | |
|---|---|---|
| Median value | 0.0 | 1.5 |
| Mean value | 0.0 | 1.5 |

*Amount in terms of total α-carotene and β-carotene content prior to heat treatment

These results, as shown in table 8, have clarified that although no effect was observed with the powdered oil and fat of comparative example 2, an effect for improving the quality of sweetness of the cola was obtained by the powdered oil and fat of example 7, which contained the carotenoid degradation product.

### [Test Example 5] (Evaluation in Yogurt, Part 4)

<Formulation of Oxidation Treatment Product from Oil and Fat to which Carotenoid is Added>

The rapeseed oil and the medium-chain fatty acid triglyceride (also referred to below as “MCT”) shown in table 9 were used as base oils, and β-carotene or astaxanthin was used as a carotenoid, to formulate oxidation treatment products of the base oils. Specifically, the β-carotene or astaxanthin was added to the base oil to reach a prescribed carotenoid content (mass ppm), and heat treatment was carried out under the heat treatment conditions indicated in table 9 while the mixture was stirred, to obtain oxidation treatment products of examples 8 to 13. As shown in table 9, the heat treatment was carried out while air was blown in a prescribed amount (0.2 L/min), except in the case of example 9. One base oil that was not subjected to heat treatment was employed as comparative example 3 to serve as a control. Table 9 shows each of the base oils used, the β-carotene content or astaxanthin content of the base oil, the heat treatment conditions, the amount of β-carotene or astaxanthin remaining after heat treatment, and the temperature×time value. In examples 8, 12, and 13, the base oil was heated at 120° C. for five hours, and then was further heated at 80° C. for five hours.

TABLE 9

| | | | | Heat treatment conditions | | | | | Amount of | |
|---|---|---|---|---|---|---|---|---|---|---|
| | | | Carotenoid | Temp. | | Temp. | | Air blowing | carotenoid | |
| | Carotenoid | | content | 1 | Time | 2 | Time | amount | remaining | Temperature × |
| | added | Base oil | Mass ppm | ° C. | h | ° C. | h | L/min | Mass ppm | time* |
| Compar. | β-carotene | MCT | 53 | | | | | | 0 | 0 |
| example 3 | | | | | | | | | | |
| Example 8 | Astaxanthin | MCT | 44 | 120 | 5 | 80 | 5 | 0.2 | 0 | 1000 |
| Example 9 | β-carotene | MCT | 30 | 80 | 171 | | | | 0 | 13680 |
| Example 10 | β-carotene | MCT | 60 | 140 | 3 | | | 0.2 | 0 | 420 |
| Example 11 | β-carotene | MCT | 28213 | 120 | 7 | | | 0.2 | 0 | 840 |
| Example 12 | β-carotene | Rapeseed | 53 | 120 | 5 | 80 | 5 | 0.2 | 0 | 1000 |
| | | oil | | | | | | | | |
| Example 13 | β-carotene | MCT | 53 | 120 | 5 | 80 | 5 | 0.2 | 0 | 1000 |

*Temperature 1 × time 1 + temperature 2 × time 2

As shown in table 9, the β-carotene or astaxanthin content included in the base oil decreased due to heat treatment, and carrying out heating for a longer period of time or raising the temperature made it possible to degrade all of the β-carotene and α-carotene in the base oil and fat. In addition, even in example 9, in which no air was blown in, it was possible to degrade all of the β-carotene in the base oil.

<Formulation of Edible Oil and Fat Composition>

1 mass % of the oil and fat compositions of examples 8 to 13, which were formulated by adding a carotenoid to a base oil and carrying out oxidation treatment and which contained carotenoid degradation products, was incorporated into rapeseed oil to formulate edible oil and fat compositions that contained 0.3-282.13 mass ppm of the carotenoid degradation products in terms of the amount of pre-oxidation-treatment carotenoids. In addition, 1 mass % of comparative example 3, which was one base oil not subjected to heat treatment, was incorporated into rapeseed oil as a control to formulate an edible oil and fat composition.

<Formulation and Evaluation of 1%-Stevia-Containing Yogurt>

A sensory evaluation was conducted on yogurt formulated by furthermore incorporating the edible oil and fat compositions formulated as described above into 1%-stevia-containing yogurt using the blends shown in table 10. Specifically, the quality of sweetness and the masking of an acrid flavor in an aftertaste upon consumption of the resultant yogurt were evaluated, where 1%-stevia-containing yogurt to which was added an edible oil and fat composition obtained through incorporation of comparative example 3, which was the one base oil not subjected to heat treatment, was used as control 1, and yogurt to which was added 5% of granulated sugar was used as control 2. The sensory evaluation was conducted by four panel experts, and moreover was conducted using an evaluation form in which ratings of 0, 1, 2, and 3 indicated by the following criteria were written on 6-cm-long line segments at intervals of 1 cm. Specifically, the panel experts plotted their evaluations on the line segments in a discretionary manner, the lengths from the rating 0 were measured in units of 0.1 cm, and said lengths were scored according to the following criteria that incorporated the evaluation values of the panel experts to thereby derive average evaluation values.

(Criteria)

(Quality of Sweetness)

3 Very close to sweetness of sugar (same as control 2)

2 Close to sweetness of sugar

1 Marginally close to sweetness of sugar

0 Different from sweetness of sugar (same as control 1)

(Masking of Acrid Flavor in Aftertaste)

3 Much weaker acrid flavor in aftertaste than with control 1, or no acrid flavor in aftertaste (same as control 2)

2 Weaker acrid flavor in aftertaste than with control 1

1 Slightly weaker acrid flavor in aftertaste than with control 1

0 Same acrid flavor in aftertaste as that in control 1, or stronger acrid flavor in aftertaste than with control 1

TABLE 10

| | | | | | | |
|---|---|---|---|---|---|---|
| Formulation | Formulation | Formulation | Formulation | Formulation | Formulation | Formulation |
| example 5-1 | example 5-2 | example 5-3 | example 5-4 | example 5-5 | example 5-6 | example 5-7 |

Blends

| | | | | | | | | |
|---|---|---|---|---|---|---|---|---|
| Edible oil | Rapeseed oil | 0.495 | 0.495 | 0.495 | 0.495 | 0.495 | 0.495 | 0.495 |
| and fat | Comparative | 0.005 | | | | | | |
| composition | example 3 | | | | | | | |
| (g) | Example 8 | | 0.005 | | | | | |
| | Example 9 | | | 0.005 | | | | |
| | Example 10 | | | | 0.005 | | | |
| | Example 11 | | | | | 0.005 | | |
| | Example 12 | | | | | | 0.005 | |
| | Example 13 | | | | | | | 0.005 |

| | | | | | | | |
|---|---|---|---|---|---|---|---|
| 1%-stevia-containing yogurt | 49.5 | 49.5 | 49.5 | 49.5 | 49.5 | 49.5 | 49.5 |
| Oil fraction (%) | 1 | 1 | 1 | 1 | 1 | 1 | 1 |
| Heat-treated oil and fat | | 100 | 100 | 100 | 100 | 100 | 100 |
| concentration (mass ppm) | | | | | | | |
| Heat-treated carotenoid | 0 | 0.0044 | 0.003 | 0.006 | 2.8213 | 0.0053 | 0.0053 |
| content* (mass ppm) | | | | | | | |
| Total mass (g) | 50 | 50 | 50 | 50 | 50 | 50 | 50 |

Results of sensory evaluation

| Quality of | Expert 1 | 0 | 2 | 2 | 1 | 1 | 1 | 2 |
|---|---|---|---|---|---|---|---|---|
| sweetness | Expert 2 | 0 | 2 | 2 | 2 | 1 | 2 | 2 |
| | Expert 3 | 0 | 1 | 1 | 1 | 1 | 2 | 2 |
| | Expert 4 | 0 | 1 | 2 | 1 | 1 | 2 | 2 |
| Median value | | 0.0 | 1.5 | 2.0 | 1.0 | 1.0 | 2.0 | 2.0 |
| Mean value | | 0.0 | 1.5 | 1.8 | 1.3 | 1.0 | 1.8 | 2.0 |
| Masking of | Expert 1 | 0 | 1 | 1 | 1 | 1 | 1 | 2 |
| acrid flavor | Expert 2 | 0 | 2 | 2 | 2 | 1 | 2 | 2 |
| in aftertaste | Expert 3 | 0 | 1 | 1 | 2 | 1 | 2 | 2 |
| | Expert 4 | 0 | 1 | 2 | 1 | 1 | 1 | 2 |

| | | | | | | | |
|---|---|---|---|---|---|---|---|
| Median value | 0.0 | 1.0 | 1.5 | 1.5 | 1.0 | 1.5 | 2.0 |
| Mean value | 0.0 | 1.3 | 1.5 | 1.5 | 1.0 | 1.5 | 2.0 |

*Amount in terms of total α-carotene and β-carotene content prior to heat treatment

These results, as shown in table 10, have clarified that the quality of sweetness of 1%-stevia-containing yogurt was more greatly improved and an effect for masking an acrid flavor in an aftertaste was more strongly obtained by the edible oil and fat compositions obtained by incorporating the oil and fat compositions of examples 8 to 13, which contained carotenoid degradation products, than by the edible oil and fat composition obtained by incorporating comparative example 3. In particular, the effect for improving the quality of sweetness of the 1%-stevia-containing yogurt and the effect for masking an acrid flavor in an aftertaste were increased in formulation example 5-7, which contained the edible oil and fat composition obtained by incorporating the oil and fat composition of example 13. In example 13, which was used in the yogurt of formulation example 5-7 for which these effects were recognized in the present sensory evaluation, the amount of the carotenoid degradation product per 1 part by mass of stevia was 5.3×10⁻⁷ parts by mass in terms of the amount of pre-degraded carotenoids.

### [Test Example 6] (Evaluation in Yogurt, Part 5)

0.1 mass % of the oil and fat compositions in examples 10 and 13 formulated according to table 9 was incorporated into rapeseed oil to formulate edible oil and fat compositions, and a sensory evaluation was conducted, using the same method as in test example 5, on yogurt formulated by incorporating the edible oil and fat compositions into 1%-stevia-containing yogurt using the blends shown in table 11. As shown in table 11, the sensory evaluation was conducted by two panel experts, and in lieu of control 1 from test example 5, the 1%-stevia-containing yogurt of formulation example 6-1, which contained an edible oil and fat composition formulated by incorporating 0.1 mass % of comparative example 3 in table 9 into rapeseed oil, was set as control 1.

TABLE 11

| | | |
|---|---|---|
| Formulation | Formulation | Formulation |
| example 6-1 | example 6-2 | example 6-3 |

Blends

| | | | | |
|---|---|---|---|---|
| Edible oil and | Rapeseed oil | 0.4995 | 0.4995 | 0.4995 |
| fat composition | Comparative | 0.0005 | | |
| (g) | example 3 | | | |
| | Example 10 | | 0.0005 | |
| | Example 13 | | | 0.0005 |

| | | | |
|---|---|---|---|
| 1%-stevia-containing yogurt | 49.5 | 49.5 | 49.5 |
| Oil fraction (%) | 1 | 1 | 1 |
| Heat-treated oil and fat | | 10 | 10 |
| concentration (mass ppm) | | | |
| Heat-treated carotenoid | 0 | 0.0006 | 0.00053 |
| content* (mass ppm) | | | |
| Total mass (g) | 50 | 50 | 50 |

Results of sensory evaluation

| | Expert 1 | 0 | 1 | 1 |
|---|---|---|---|---|
| | Expert 2 | 0 | 1 | 1 |
| Median value | | 0.0 | 1.0 | 1.0 |
| Mean value | | 0.0 | 1.0 | 1.0 |
| | Expert 1 | 0 | 1 | 1 |
| | Expert 2 | 0 | 1 | 1 |

| | | | |
|---|---|---|---|
| Median value | 0.0 | 1.0 | 1.0 |
| Mean value | 0.0 | 1.0 | 1.0 |

*Amount in terms of total α-carotene and β-carotene content prior to heat treatment

These results, as shown in table 11, have clarified that an effect for improving the quality of sweetness of the 1%-stevia-containing yogurt was more strongly obtained by the edible oil and fat compositions obtained by incorporating the oil and fat compositions of examples 10 and 13, which contained the carotenoid degradation products, than by the edible oil and fat composition obtained by incorporating comparative example 3, which was one base oil not subjected to heat treatment. In example 13, which was used in the yogurt of formulation example 6-3 for which these effects were recognized in the present sensory evaluation, the amount of the carotenoid degradation product per 1 part by mass of stevia was 5.3×10⁻⁸ parts by mass in terms of the amount of pre-degraded carotenoids.

### [Test Example 7] (Evaluation in Yogurt, Part 6)

<Evaluation in Other High-Intensity-Sweetener-Containing Yogurt>

1 mass % of the oil and fat compositions in examples 10 and 13 formulated according to table 9 was incorporated into rapeseed oil to formulate edible oil and fat compositions, and a sensory evaluation was conducted, using the same method as in test example 5, on yogurt formulated by incorporating the edible oil and fat compositions into each of 0.5%-acesulfame-potassium-containing yogurt, 0.1%-aspartame-containing yogurt, 0.05%-sucralose-containing yogurt, and 3.5%-Sugar-cut-containing yogurt using the blends shown in table 12. As shown in table 12, the sensory evaluation was conducted by three panel experts, and in lieu of control 1 from test example 5, the following high-intensity-sweetener-containing yogurts were set as respective controls 1. Formulation example 7-1: 0.5%-acesulfame-potassium-containing yogurt that contained an edible oil and fat composition formulated by incorporating 1 mass % of comparative example 3 in table 9 into rapeseed oil; formulation example 7-4: 0.1%-aspartame-containing yogurt that contained an edible oil and fat composition formulated by incorporating 1 mass % of comparative example 3 in table 9 into rapeseed oil; formulation example 7-7: 0.05%-sucralose-containing yogurt that contained an edible oil and fat composition formulated by incorporating 1 mass % of comparative example 3 in table 9 into rapeseed oil; formulation example 7-10: 3.5%-Sugar-cut-containing yogurt that contained an edible oil and fat composition formulated by incorporating 1 mass % of comparative example 3 in table 9 into rapeseed oil. The evaluation of an acrid flavor in an aftertaste was conducted only for formulation examples 7-1 to 7-3, which contained acesulfame potassium.

TABLE 12

| | | | | | |
|---|---|---|---|---|---|
| Formulation | Formulation | Formulation | Formulation | Formulation | Formulation |
| example 7-1 | example 7-2 | example 7-3 | example 7-4 | example 7-5 | example 7-6 |

Blends

| | | | | | | | |
|---|---|---|---|---|---|---|---|
| Edible oil | Rapeseed oil | 0.495 | 0.495 | 0.495 | 0.495 | 0.495 | 0.495 |
| and fat | Comparative | 0.005 | | | 0.005 | | |
| composition | example 3 | | | | | | |
| (g) | Example 10 | | 0.005 | | | 0.005 | |
| | Example 13 | | | 0.005 | | | 0.005 |

| | | | | | | |
|---|---|---|---|---|---|---|
| 0.5%-acesulfame-potassium- | 49.5 | 49.5 | 49.5 | | | |
| containing yogurt | | | | | | |
| 0.1%-aspartame-containing | | | | 49.5 | 49.5 | 49.5 |
| yogurt | | | | | | |
| 0.05%-sucralose-containing | | | | | | |
| yogurt | | | | | | |
| 3.5%-Sugar-cut-containing | | | | | | |
| yogurt | | | | | | |
| Oil fraction (%) | 1 | 1 | 1 | 1 | 1 | 1 |
| Heat-treated oil and fat | | 100 | 100 | 100 | 100 | 100 |
| concentration (mass ppm) | | | | | | |
| Heat-treated carotenoid | 0 | 0.006 | 0.0053 | 0 | 0.006 | 0.0053 |
| content* (mass ppm) | | | | | | |
| Total mass (g) | 50 | 50 | 50 | 50 | 50 | 50 |

Results of sensory evaluation

| Quality of | Expert 1 | 0 | 1 | 1 | 0 | 2 | 2 |
|---|---|---|---|---|---|---|---|
| sweetness | Expert 2 | 0 | 1 | 1 | 0 | 1 | 1 |
| | Expert 3 | 0 | 1 | 1 | 0 | 0 | 0 |
| Median value | | 0.0 | 1.0 | 1.0 | 0.0 | 1.0 | 1.0 |
| Mean value | | 0.0 | 1.0 | 1.0 | 0.0 | 1.0 | 1.0 |
| Masking of | Expert 1 | 0 | 1 | 1 | | | |
| acrid flavor | Expert 2 | 0 | 1 | 2 | | | |
| in aftertaste | Expert 3 | 0 | 1 | 1 | | | |

| | | | |
|---|---|---|---|
| Median value | 0.0 | 1.0 | 1.0 |
| Mean value | 0.0 | 1.0 | 1.3 |

| | | | | | |
|---|---|---|---|---|---|
| Formulation | Formulation | Formulation | Formulation | Formulation | Formulation |
| example 7-7 | example 7-8 | example 7-9 | example 7-10 | example 7-11 | example 7-12 |

Blends

| | | | | | | | |
|---|---|---|---|---|---|---|---|
| Edible oil | Rapeseed oil | 0.495 | 0.495 | 0.495 | 0.495 | 0.495 | 0.495 |
| and fat | Comparative | 0.005 | | | 0.005 | | |
| composition | example 3 | | | | | | |
| (g) | Example 10 | | 0.005 | | | 0.005 | |
| | Example 13 | | | 0.005 | | | 0.005 |

| | | | | | | |
|---|---|---|---|---|---|---|
| 0.5%-acesulfame-potassium- | | | | | | |
| containing yogurt | | | | | | |
| 0.1%-aspartame-containing | | | | | | |
| yogurt | | | | | | |
| 0.05%-sucralose-containing | 49.5 | 49.5 | 49.5 | | | |
| yogurt | | | | | | |
| 3.5%-Sugar-cut-containing | | | | 49.5 | 49.5 | 49.5 |
| yogurt | | | | | | |
| Oil fraction (%) | 1 | 1 | 1 | 1 | 1 | 1 |
| Heat-treated oil and fat | 100 | 100 | 100 | 100 | 100 | 100 |
| concentration (mass ppm) | | | | | | |
| Heat-treated carotenoid | 0 | 0.006 | 0.0053 | 0 | 0.006 | 0.0053 |
| content* (mass ppm) | | | | | | |
| Total mass (g) | 50 | 50 | 50 | 50 | 50 | 50 |

Results of sensory evaluation

| Quality of | Expert 1 | 0 | 1 | 1 | 0 | 1 | 2 |
|---|---|---|---|---|---|---|---|
| sweetness | Expert 2 | 0 | 1 | 1 | 0 | 2 | 2 |
| | Expert 3 | 0 | 1 | 1 | 0 | 2 | 2 |
| Median value | | 0.0 | 1.0 | 1.0 | 0.0 | 2.0 | 2.0 |
| Mean value | | 0.0 | 1.0 | 1.0 | 0.0 | 1.7 | 2.0 |
| Masking of | Expert 1 | | | | | | |
| acrid flavor | Expert 2 | | | | | | |
| in aftertaste | Expert 3 | | | | | | |

Median value
Mean value

*Amount in terms of total α-carotene and β-carotene content prior to heat treatment

In these results, as shown in table 12, an effect for improving the quality of sweetness was obtained in all of the high-intensity-sweetener-containing yogurts shown in table 12 by the edible oil and fat compositions that contained carotenoid degradation products. An acrid flavor in an aftertaste was evaluated only for the 0.5%-acesulfame-potassium-containing yogurt, the high-intensity sweetener therein having a particularly strong acrid flavor among the high-intensity sweeteners shown in table 12. The results of this evaluation have clarified that an effect for masking an acrid flavor in an aftertaste was obtained by the edible oil and fat compositions that contained carotenoid degradation products. In example 13, which was used in the yogurt of formulation examples 7-3, 7-6, and 7-9 for which these effects were recognized in the present sensory evaluation, the amount of the carotenoid degradation product per 1 part by mass of the respective high-intensity sweetener was 1.1×10⁻⁶ parts by mass for the acesulfame potassium, 5.3×10⁻⁶ parts by mass for the aspartame, and 1.1×10⁻⁶ parts by mass for the sucralose, in terms of the amount of pre-degraded carotenoids.

### [Test Example 8] (Evaluation in Aqueous Solution Containing High-Intensity Sweetener)

<Formulation of Aqueous Solution Containing Carotenoid Degradation Product>

An aqueous carotenoid degradation product was extracted through liquid extraction using the oil and fat composition of example 6, which contained a carotenoid degradation product formulated by heat-treating red palm oil. Specifically, 15 mL of the oil and fat composition of example 6 and 15 mL of water were introduced into a 50-mL tube, the contents were stirred for 30 minutes, and the resulting combination was separated into an oil phase and an aqueous phase by centrifugation, the oil phase being removed to recover the aqueous phase. The resultant aqueous solution was used in the tests below as an oil and fat aqueous extract of example 14.

<Formulation and Evaluation of Aqueous Solution Containing High-Intensity Sweetener>

Each of 1% of stevia, 0.5% of acesulfame potassium, 0.1% of aspartame, and 0.05% of sucralose was incorporated into water to formulate aqueous solutions shown in table 13 (also referred to below as “1%-stevia-containing aqueous solution,” “0.5%-acesulfame-potassium-containing aqueous solution,” “0.1%-aspartame-containing aqueous solution,” and “0.05%-sucralose-containing aqueous solution”). A sensory evaluation was conducted on aqueous solutions obtained by adding the oil and fat aqueous extract of example 14 formulated as described above using the blends shown in table 13. Specifically, the quality of sweetness and the masking of an acrid flavor in an aftertaste upon consumption of the resultant aqueous solutions were evaluated, where substances obtained by adding water as comparative example 3 instead of the oil and fat aqueous extract to the respective high-intensity-sweetener-containing aqueous solutions were used as controls 1, and substances obtained by adding 5% of granulated sugar to said aqueous solutions were used as controls 2. The sensory evaluation was conducted by two panel experts, and moreover was conducted using an evaluation form in which ratings of 0, 1, 2, and 3 indicated by the following criteria were written on 6-cm-long line segments at intervals of 1 cm. Specifically, the panel experts plotted their evaluations on the line segments in a discretionary manner, the lengths from the rating 0 were measured in units of 0.1 cm, and said lengths were scored according to the following criteria that incorporated the evaluation values of the panel experts to thereby derive average evaluation values. The evaluation of an acrid flavor in an aftertaste was conducted only for formulation examples 8-1 to 8-4, which contained stevia or acesulfame potassium.

(Criteria)

(Quality of Sweetness)

3 Very close to sweetness of sugar (same as control 2)

2 Close to sweetness of sugar

1 Marginally close to sweetness of sugar

0 Different from sweetness of sugar (same as control 1)

(Masking of Acrid Flavor in Aftertaste)

3 Much weaker acrid flavor in aftertaste than with control 1, or no acrid flavor in aftertaste (same as control 2)

2 Weaker acrid flavor in aftertaste than with control 1

1 Slightly weaker acrid flavor in aftertaste than with control 1

0 Same acrid flavor in aftertaste as that in control 1, or stronger acrid flavor in aftertaste than with control 1

TABLE 13

| | | | | | | | |
|---|---|---|---|---|---|---|---|
| Formulation | Formulation | Formulation | Formulation | Formulation | Formulation | Formulation | Formulation |
| example 8-1 | example 8-2 | example 8-3 | example 8-4 | example 8-5 | example 8-6 | example 8-7 | example 8-8 |

Blends

| | | | | | | | | | |
|---|---|---|---|---|---|---|---|---|---|
| Water (g) | Comparative | 0.5 | | 0.5 | | 0.5 | | 0.5 | |
| | example 3 | | | | | | | | |
| Oil and fat | Example 14 | | 0.5 | | 0.5 | | 0.5 | | 0.5 |
| aqueous | | | | | | | | | |
| extract (g) | | | | | | | | | |

| | | | | | | | | |
|---|---|---|---|---|---|---|---|---|
| 1%-stevia-containing aqueous | 49.5 | 49.5 | | | | | | |
| solution | | | | | | | | |
| 0.5%-acesulfame-potassium- | | | 49.5 | 49.5 | | | | |
| containing aqueous solution | | | | | | | | |
| 0.1%-aspartare-containing | | | | | 49.5 | 49.5 | | |
| aqueous solution | | | | | | | | |
| 0.05%-sucralose-containing | | | | | | | 49.5 | 49.5 |
| aqueous solution | | | | | | | | |
| Total mass (g) | 50 | 50 | 50 | 50 | 50 | 50 | 50 | 50 |

Results of sensory evaluation

| Quality of | Expert 1 | 0.0 | 2.5 | 0.0 | 2.0 | 0.0 | 1.5 | 0.0 | 1.5 |
|---|---|---|---|---|---|---|---|---|---|
| sweetness | Expert 2 | 0.0 | 2.0 | 0.0 | 2.0 | 0.0 | 2.0 | 0.0 | 1.5 |
| Median value | | 0.0 | 2.3 | 0.0 | 2.0 | 0.0 | 1.8 | 0.0 | 1.5 |
| Mean value | | 0.0 | 2.3 | 0.0 | 2.0 | 0.0 | 1.8 | 0.0 | 1.5 |
| Masking of | Expert 1 | 0.0 | 2.5 | 0.0 | 2.0 | — | — | — | — |
| acrid flavor | Expert 2 | 0.0 | 2.5 | 0.0 | 2.0 | — | — | — | — |
| in aftertaste | | | | | | | | | |

| | | | | | | | | |
|---|---|---|---|---|---|---|---|---|
| Median value | 0.0 | 2.5 | 0.0 | 2.0 | — | — | — | — |
| Mean value | 0.0 | 2.5 | 0.0 | 2.0 | — | — | — | — |

These results, as shown in table 13, have clarified that although no effect was observed with only the water of comparative example 3, an effect for improving the quality of sweetness of the high-intensity-sweetener-containing aqueous solutions was obtained by the oil and fat aqueous extract of example 14, which was in the form of an aqueous solution containing the carotenoid degradation product. An acrid flavor in an aftertaste was evaluated only for the 1%-stevia-containing aqueous solution and the 0.5%-acesulfame-potassium-containing aqueous solution, the high-intensity sweeteners therein having a particularly strong acrid flavor among the high-intensity sweeteners shown in table 13. The results of this evaluation have clarified that an effect for masking an acrid flavor in an aftertaste was obtained by the oil and fat aqueous extract of example 14, which was in the form of an aqueous solution containing the carotenoid degradation product.

### [Test Example 9] (Evaluation in Yogurt, Part 7)

<Powderization of Aqueous Solution Containing Carotenoid Degradation Product>

The aqueous solution containing the carotenoid degradation product formulated according to test example 8 was powderized. Specifically, dextrin was added to the aqueous solution formulated according to test example 8 so as to reach a concentration of 65% (w/w), and the resultant mixture was stirred using a homogenizer at 60° C., heated and dissolved, and then spray-dried. The resultant powder was used in the tests below as an oil and fat aqueous extract powder of example 15. A substance obtained by spray-drying only dextrin without adding the aqueous solution formulated according to test example 8 was formulated as a control, which was used in the tests below as comparative example 4.

<Evaluation in High-Intensity-Sweetener-Containing Yogurt>

A sensory evaluation was conducted, using the same method as in test example 1, on yogurt formulated by incorporating the oil and fat aqueous extract powder of example 15 formulated as described above or the dextrin powder of comparative example 4 into each of 1%-stevia-containing yogurt, 0.5%-acesulfame-potassium-containing yogurt, 0.1%-aspartame-containing yogurt, and 0.05%-sucralose-containing yogurt using the blends shown in table 14. As shown in table 14, the sensory evaluation was conducted by two panel experts, and in lieu of control 1 from test example 1, the following high-intensity-sweetener-containing yogurts were set as respective controls 1. Formulation example 9-1: 1%-stevia-containing yogurt that contained the dextrin powder serving as comparative example 4; formulation example 9-5: 0.5%-acesulfame-potassium-containing yogurt that contained the dextrin powder serving as comparative example 4; formulation example 9-9: 0.1%-aspartame-containing yogurt that contained the dextrin powder serving as comparative example 4; formulation example 9-13: 0.05%-sucralose-containing yogurt that contained the dextrin powder serving as comparative example 4. The evaluation of an acrid flavor in an aftertaste was conducted only for formulation examples 9-1 to 9-8, which contained stevia or acesulfame potassium.

TABLE 14-1

| | | | | | | | |
|---|---|---|---|---|---|---|---|
| Formulation | Formulation | Formulation | Formulation | Formulation | Formulation | Formulation | Formulation |
| example 9-1 | example 9-2 | example 9-3 | example 9-4 | example 9-5 | example 9-6 | example 9-7 | example 9-8 |

Blends

| Dextrin | Comparative | 0.5 | | | | 0.5 | | | |
|---|---|---|---|---|---|---|---|---|---|
| powder (g) | example 4 | | | | | | | | |
| Oil and fat | Example 15 | | 0.5 | 0.25 | 0.05 | | 0.5 | 0.25 | 0.05 |
| aqueous | | | | | | | | | |
| extract | | | | | | | | | |
| powder (g) | | | | | | | | | |
| 1%-stevia-containing yogurt | | 49.5 | 49.5 | 49.75 | 49.95 | | | | |
| 0.5%-acesulfame-potassium- | | | | | | 49.5 | 49.5 | 49.75 | 49.95 |
| containing yogurt | | | | | | | | | |
| 0.1%-aspartame-containing | | | | | | | | | |
| yogurt | | | | | | | | | |
| 0.05%-sucralose-containing | | | | | | | | | |
| yogurt | | | | | | | | | |
| Total mass (g) | | 50 | 50 | 50 | 50 | 50 | 50 | 50 | 50 |

Results of sensory evaluation

| | | | | | | | | | |
|---|---|---|---|---|---|---|---|---|---|
| Quality of | Expert 1 | 0.0 | 2.5 | 2.0 | 1.0 | 0.0 | 2.0 | 1.5 | 1.0 |
| sweetness | Expert 2 | 0.0 | 2.5 | 2.5 | 1.5 | 0.0 | 2.0 | 1.5 | 1.5 |
| Median value | | 0.0 | 2.5 | 2.3 | 1.3 | 0.0 | 2.0 | 1.5 | 1.3 |
| Mean value | | 0.0 | 2.5 | 2.3 | 1.3 | 0.0 | 2.0 | 1.5 | 1.3 |
| Masking of | Expert 1 | 0.0 | 2.0 | 2.0 | 1.0 | 0.0 | 2.0 | 2.0 | 1.0 |
| acrid flavor | Expert 2 | 0.0 | 2.0 | 2.0 | 1.0 | 0.0 | 2.0 | 1.5 | 1.0 |
| in aftertaste | | | | | | | | | |

| | | | | | | | | |
|---|---|---|---|---|---|---|---|---|
| Median value | 0.0 | 2.0 | 2.0 | 1.0 | 0.0 | 2.0 | 1.8 | 1.0 |
| Mean value | 0.0 | 2.0 | 2.0 | 1.0 | 0.0 | 2.0 | 1.8 | 1.0 |

| | | | | | | | |
|---|---|---|---|---|---|---|---|
| Formula- | Formula- | Formula- | Formula- | Formula- | Formula- | Formula- | Formula- |
| tion exam- | tion exam- | tion exam- | tion exam- | tion exam- | tion exam- | tion exam- | tion exam- |
| ple 9-9 | ple 9-10 | ple 9-11 | ple 9-12 | ple 9-13 | ple 9-14 | ple 9-15 | ple 9-16 |

Blends

| | | | | | | | | | |
|---|---|---|---|---|---|---|---|---|---|
| Dextrin | Comparative | 0.5 | | | | 0.5 | | | |
| powder (g) | example 4 | | | | | | | | |
| Oil and fat | Example 15 | | 0.5 | 0.25 | 0.05 | | 0.5 | 0.25 | 0.05 |
| aqueous | | | | | | | | | |
| extract | | | | | | | | | |
| powder (g) | | | | | | | | | |

| | | | | | | | | |
|---|---|---|---|---|---|---|---|---|
| 1%-stevia-containing yogurt | | | | | | | | |
| 0.5%-acesulfame-potassium- | | | | | | | | |
| containing yogurt | | | | | | | | |
| 0.1%-aspartame-containing | 49.5 | 49.5 | 49.75 | 49.95 | | | | |
| yogurt | | | | | | | | |
| 0.05%-sucralose-containing | | | | | 49.5 | 49.5 | 49.75 | 49.95 |
| yogurt | | | | | | | | |
| Total mass (g) | 50 | 50 | 50 | 50 | 50 | 50 | 50 | 50 |

Results of sensory evaluation

| | | | | | | | | | |
|---|---|---|---|---|---|---|---|---|---|
| Quality of | Expert 1 | 0.0 | 1.5 | 1.0 | 1.0 | 0.0 | 2.0 | 2.0 | 1.5 |
| sweetness | Expert 2 | 0.0 | 1.5 | 1.5 | 1.0 | 0.0 | 2.0 | 1.5 | 1.5 |

| | | | | | | | | |
|---|---|---|---|---|---|---|---|---|
| Median value | 0.0 | 1.5 | 1.3 | 1.0 | 0.0 | 2.0 | 1.8 | 1.5 |
| Mean value | 0.0 | 1.5 | 1.3 | 1.0 | 0.0 | 2.0 | 1.8 | 1.5 |

These results, as shown in table 14, have clarified that although no effect was observed with only the dextrin powder of comparative example 4, an effect for improving the quality of sweetness of the high-intensity-sweetener-containing yogurts was obtained by the oil and fat aqueous extract powder of example 15, which was in a form obtained by powderizing an aqueous solution containing the carotenoid degradation product. An acrid flavor in an aftertaste was evaluated only for the 1%-stevia-containing yogurt and the 0.5%-acesulfame-potassium-containing yogurt, the high-intensity sweeteners therein having a particularly strong acrid flavor among the high-intensity sweeteners shown in table 14. The results of this evaluation have clarified that an effect for masking an acrid flavor in an aftertaste was obtained by the oil and fat aqueous extract powder of example 15, which was in a form obtained by powderizing an aqueous solution containing the carotenoid degradation product.

### [Test Example 10] (Evaluation in Cola, Part 2)

The oil and fat aqueous extract powder of example 15 formulated as described above or the dextrin powder of comparative example 4 was added to zero-calorie cola (“Pepsi Japan cola zero” manufactured by Suntory Foods Co., Ltd.) using the blends shown in table 15, the resultant mixture was adequately stirred and then cooled to 4° C., and a sensory evaluation was conducted using the same method as in test example 4. As shown in table 15, the sensory evaluation was conducted by two panel experts, and in lieu of control 1 from test example 4, zero-calorie cola of preparation example 10-1, which contained the dextrin powder of comparative example 4, was set as control 1.

TABLE 15

| | | | |
|---|---|---|---|
| Formulation | Formulation | Formulation | Formulation |
| example 10-1 | example 10-2 | example 10-3 | example 10-4 |

Blends

| | | | | | |
|---|---|---|---|---|---|
| Dextrin powder | Comparative | 0.5 | | | |
| (g) | example 4 | | | | |
| Oil and fat | Example 15 | | 0.5 | 0.25 | 0.05 |
| aqueous extract | | | | | |
| powder (g) | | | | | |

| | | | | |
|---|---|---|---|---|
| Zero-calorie cola | 49.5 | 49.5 | 49.75 | 49.95 |
| Total mass (g) | 50 | 50 | 50 | 50 |

Results of sensory evaluation

| | | | | | |
|---|---|---|---|---|---|
| Quality of | Expert 1 | 0.0 | 1.5 | 0.5 | 0.5 |
| sweetness | Expert 2 | 0.0 | 1.5 | 1.0 | 0.5 |

| | | | | |
|---|---|---|---|---|
| Median value | 0.0 | 1.5 | 0.8 | 0.5 |
| Mean value | 0.0 | 1.5 | 0.8 | 0.5 |

These results, as shown in table 15, have clarified that although no effect was observed with only the dextrin powder of comparative example 4, an effect for improving the quality of sweetness of the zero-calorie cola was obtained by the oil and fat aqueous extract powder of example 15, which was in a form obtained by powderizing an aqueous solution containing the carotenoid degradation product.

### Formulation Example 1

0.5 g of the oil and fat composition of example 6, which contained the carotenoid degradation product formulated by heat-treating red palm oil, was mixed with 50 g of stevia to manufacture a high-intensity sweetener composition.

1. A taste-improving agent for a high-intensity sweetener, the taste-improving agent containing a carotenoid degradation product as an active ingredient.

2. The taste-improving agent according to claim 1, wherein the carotenoid degradation product is obtained by degrading one or more selected from the group consisting of carotenes and xanthophylls.

3. The taste-improving agent according to claim 1, wherein the taste-improving agent contains the carotenoid degradation product in an amount of 1 mass ppm or more and 40000 mass ppm or less in terms of the amount of pre-degraded carotenoids.

4. The taste-improving agent according to claim 1, wherein the carotenoid degradation product is obtained by degrading a carotenoid through heating and oxidation.

5. The taste-improving agent according to claim 1, wherein the taste-improving agent is in the form of an oil and fat composition.

6. The taste-improving agent according to claim 5, wherein the taste-improving agent is in the form of a powdered oil and fat containing the carotenoid degradation product.

7. The taste-improving agent according to claim 1, wherein the taste-improving agent is in the form of an aqueous solution containing the carotenoid degradation product.

8. A method for manufacturing a taste-improving agent for a high-intensity sweetener, the method including a step for carrying out an oxidation treatment on carotenoids in an oil and fat to obtain a carotenoid degradation product.

9. The manufacturing method according to claim 8, wherein the oil and fat is obtained through a step for adding a carotenoid to a raw-material oil and fat.

10. The manufacturing method according to claim 8, wherein the oil and fat is a palm-based oil and fat in which the total β-carotene and α-carotene content is 50 mass ppm or more and 2000 mass ppm or less.

11. The manufacturing method according to claim 8, wherein the oil and fat has an iodine value of 0 or greater and 140 or lower.

12. The manufacturing method according to claim 8, wherein the oxidation treatment involves oxidizing the oil and fat so as to reach a peroxide value of 3 or greater and 250 or lower.

13. The manufacturing method according to claim 8, wherein the oxidation treatment is carried out through a heat treatment at a temperature of 50° C. or greater and 220° C. or lower for 0.1 hour or more and 240 hours or less.

14. The manufacturing method according to claim 8, wherein the oxidation treatment is carried out with oxygen supplying.

15. The manufacturing method according to claim 8, wherein the method also includes a step for mixing the carotenoid degradation product with an oil and fat.

16. The manufacturing method according to claim 8, wherein the carotenoid degradation product is included in the taste-improving agent in an amount of 1 mass ppm or more and 40000 mass ppm or less in terms of the amount of pre-degraded carotenoids.

17. The manufacturing method according to claim 8, wherein the oxidation treatment is carried out through heat treatment under conditions such that the integration amount obtained by multiplying the heating temperature (° C.) by the heating time (hours) is 20 or more and 20000 or less.

18. The manufacturing method according to claim 8, wherein the method also includes a step for powderizing the carotenoid degradation product together with a solid fat.

19. The manufacturing method according to claim 8, wherein the method also includes a step for mixing the carotenoid degradation product with water and harvesting an aqueous phase to obtain an aqueous solution of the carotenoid degradation product.

20. The manufacturing method according to claim 19, wherein the method also includes a step for adding a diluent to the aqueous solution and performing spray-drying to obtain a powder that contains the carotenoid degradation product.

21. A method for improving the taste of a food product that includes a high-intensity sweetener, the method involving incorporating a carotenoid degradation product into the food product.

22. The taste improvement method according to claim 21, wherein the carotenoid degradation product is incorporated into the food product in an amount of 1×10⁻⁵ mass ppm or more and 1 mass ppm or less in terms of the amount of pre-degraded carotenoids.

23. A method for manufacturing a food product that includes a high-intensity sweetener, the method including a step for adding a carotenoid degradation product to a food product.

24. A high-intensity sweetener composition including a high-intensity sweetener and a carotenoid degradation product.
